(19) United States
(12) Patent Application Publication
(10) Pub. No.: US 2008/0195872 A1
(43) Pub. Date: Aug. 14, 2008

(54) Method and Device for Protecting Data Stored in a Computing Device

(75) Inventors: Andrew Chow, Singapore (SG); Ser Yen Lee, Singapore (SG); Chee We Ng, Singapore (SG); Varkateswara Rao Gattameni, Singapore (SG)

Correspondence Address: SUGHRUE MION, PLLC, 2100 PENNSYLVANIA AVENUE, N.W., SUITE 800, WASHINGTON, DC, 20037, US

(73) Assignee: DIGISAFE PTE LTD, Singapore (SG)

(21) Appl. No.: 10/593,302

(22) PCT Filed: Mar. 17, 2005
(86) PCT No.: PCT/SG2005/000084

§ 371 Date: Nov. 28, 2007

(30) Foreign Application Priority Data
Mar. 17, 2004 (AU) 2004901393

(51) Int. Cl. G06F 12/14

(52) U.S. Cl. 713/193

(57) ABSTRACT

A device (10) for protecting data, comprising a first interface (18) for connection to a computing device, a second interface for connection to a data storage (20), an encryptor (22) located in-line between the first interface (18) and the second interface, a control system (30), and a memory (24). The memory (24) includes program data (26) executable on the computing device to perform user authentication, the control system (30) is configured to initially expose the memory (24) to the interface to facilitate user authentication and to expose the encryptor (22) to the interface only upon successful user authentication, and the encryptor (22) is operable to encrypt on the fly data received from the first interface (18) and to forward the data once encrypted to the second interface and to decrypt on the fly data received from the second interface and to forward the data once decrypted to the first interface (18).

### FIELD OF THE INVENTION

The present invention relates to a method and device for protecting data stored in a computing device, of particular but by no means exclusive application in protecting data stored in a portable computing device.

### BACKGROUND TO INVENTION

Computers and other computing devices are used to store important data that can be easily compromised when an unauthorized user illegally accesses the device, or when the device is stolen.

In the case of portable computers, such as personal digital assistants, laptop computers and notebook computers, the risk is particularly high owing to the greater ease with which such devices can be misplaced or stolen. According to Kensington Technology Group Notebook Security Survey 2001 and 2003 CSI/FBI Computer Crime & Security Survey, a typical medium-sized company loses about 11 notebooks annually, with an average financial loss of US$64,000 per notebook.

Existing software exists in which the hard disk of a notebook is protected by encryption. These software solutions have inherent problems, which include operating system dependencies, a need for device drivers, and a need for patches when the device is upgraded, and the like. Most software solutions also leave the operating system unencrypted.

Hardware solutions exist in which an additional interface is added between the hard disk and the device's IDE/ATA (Integrated Drive Electronics/AT Attachment) bus. Although such interfaces do not have the problems associated with the software solutions described above, these hardware solutions cannot be easily implemented on portable computing devices such as notebook computers because additional interface hardware cannot be accommodated in the space normally occupied by, in a notebook computer, a hard disk. In addition, these hardware solutions often require an additional interface into which a hardware key is inserted in order to authenticate the user to the hardware encryptor before activating the hardware encryption/decryption device. This interface is necessary because the hardware solution has no way of interfacing to other authentication devices, such as keyboards. This hardware interface cannot, therefore, be implemented on the portable computing device without customizing the device.

### SUMMARY OF THE INVENTION

It is an object of the present invention, therefore, to provide a method and device for protecting data stored in a computing device, such as a notebook computer.

The present invention provides a device for protecting data, comprising:
an interface for connection to a computing device;
a data storage;
an encryptor located in-line between said interface and said data storage;
a control system; and
a memory;
wherein said memory includes program data executable on said computing device to perform user authentication, said control system is configured to initially expose said memory to said interface to facilitate user authentication and to expose said encryptor to said interface only upon successful user authentication, and said encryptor is operable to encrypt on the fly data received from said interface and to forward said data once encrypted to said data storage and to decrypt on the fly data received from said data storage and to forward said data once decrypted to said interface.

Thus, the data stored in the data storage is encrypted, but the user need not be aware of the encryption or decryption processes.

In one embodiment, the control system is configured to reboot said computing device after successful user authentication and before exposing said encryptor to said interface.

The memory may comprise a portion of a memory storage system provided with one or more bootable programs.

The computing device could be any such device, but the invention will provide particular benefit with portable computing devices that—as discussed above—are most vulnerable to unauthorized data access.

The present invention also provides a device for protecting data, comprising:
a first interface for connection to a computing device;
a second interface for connection to a data storage;
an encryptor located in-line between said first interface and said second interface;
a control system; and
a memory;
wherein said memory includes program data executable on said computing device to perform user authentication, said control system is configured to initially expose said memory to said interface to facilitate user authentication and to expose said encryptor to said interface only upon successful user authentication, and said encryptor is operable to encrypt on the fly data received from said first interface and to forward said data once encrypted to said second interface and to decrypt on the fly data received from said second interface and to forward said data once decrypted to said first interface.

The present invention also provides a method of protecting data, comprising:
locating an encryptor in-line between a data storage and an interface to a computing device;
exposing a memory to said interface to facilitate user authentication;
exposing said encryptor to said interface only upon successful user authentication;
encrypting on the fly data received from said first interface and forwarding said data once encrypted to said second interface; and
decrypting on the fly data received from said second interface and forwarding said data once decrypted to said first interface.

### BRIEF DESCRIPTION OF THE DRAWINGS

In order that the invention may be more clearly ascertained, preferred embodiments will now be described, by way of example, with reference to the accompanying drawings, in which:

FIG. 1 is a schematic view of a data protection device according to an embodiment of the present invention, with a portable computing device with which the device is to be used;

FIG. 2 is a photograph of one embodiment of the data protection device of FIG. 1; and

FIG. 3 is a schematic view of the functional components of the data protection device of FIG. 1;

FIG. 4 is a schematic view of the functional components of a data protection device according to another embodiment of the present invention.

### DETAILED DESCRIPTION OF THE INVENTION

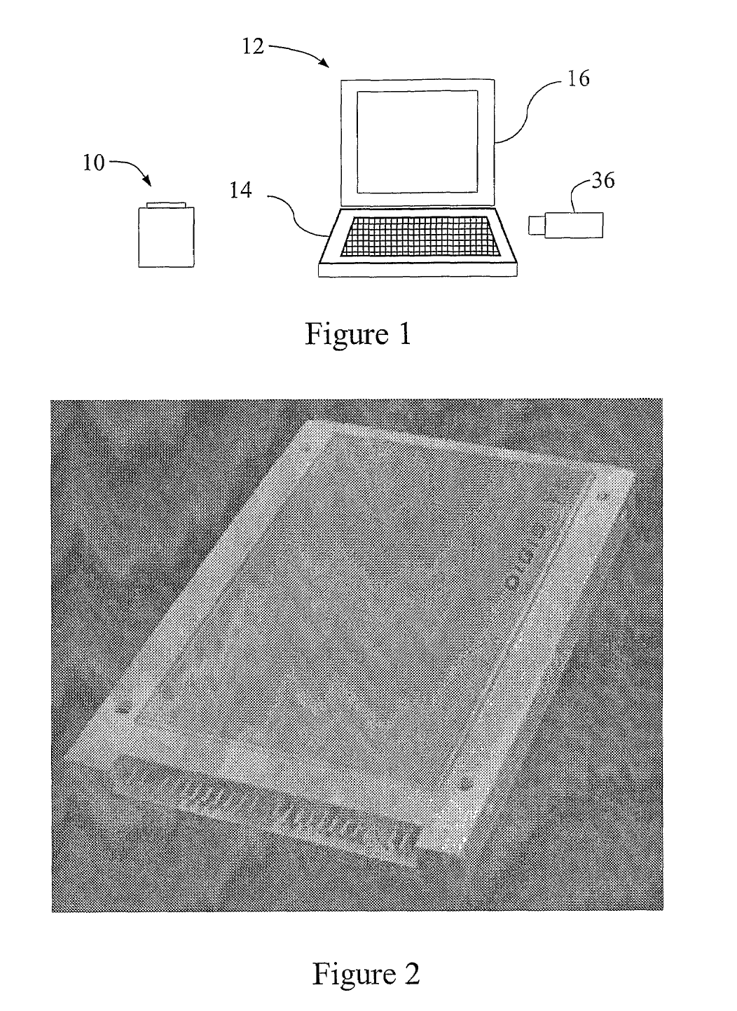

A data protection device according to an embodiment of the present invention is shown generally at 10 in FIG. 1, together with a portable computing device in the form of a notebook computer 12 with which the device 10 is to be used. The notebook computer 12 includes an integrated CPU/keyboard case 14 and an LCD display 16. In use, the device 10 is located within the CPU/keyboard case 14 and so in not visible.

The device 10 has the same form factor and hardware interface as the standard data storage device (viz. a hard disk) that would normally be provided in the notebook computer 12; device 10 thus replaces that usual storage device, and is designed to be mounted within a notebook computer like any ordinary 2.5″ hard disk for notebooks.

The device 10, however, contains a hardware encryption module together with its own storage medium as is described below. The device 10 thus requires neither an additional hardware interface, nor an additional interface for a hardware key to be inserted.

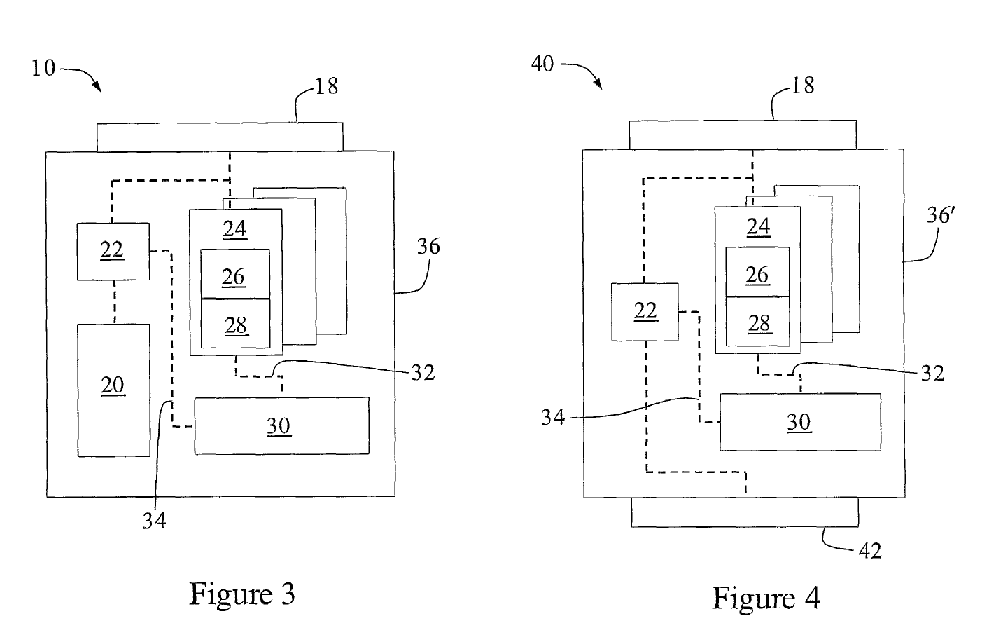

FIG. 2 is a photograph of an embodiment of the data protection device of FIG. 1, adapted for use with a notebook or other compact computer. FIG. 3 is a block diagram of the functional components of device 10. These components include an interface 18 of the same type as the hardware interface (in this embodiment, an ATA or SATA interface) for the standard storage medium otherwise used by notebook computer 12.

Device 10 also includes an encrypted storage medium 20 (in this embodiment, a hard disk) and an in-line encryptor 22 for the encrypted storage medium 20. The in-line encryptor 22 is exposed to the hardware interface 18, and performs encryption and decryption on the fly when data is written or read through the interface 18.

Device 10 further includes multiple storage system 24, which contains bootable programs 26 for the notebook computer 12. These bootable programs 26 are used for, but are not limited to, the following functions:

1) Authentication of users upon powering on the notebook computer 12;

2) Simulation of a normal operating system booting process so that users need not realize that there is protected data inside the device 10. Thus, at boot-up a normal operating system booting up is emulated so as not to arouse any suspicion that device 10 holds protected data storage.

For this notebook hard disk implementation, storage system 24 contains not only bootable programs 26 but also the boot record 28 necessary to load the bootable program 26. The storage system 24 may also contain user settings, such as the number of allowed failed authorization attempts, and other customizable settings. The credentials that a user must provide to authenticate him or herself, such as a one-way hash function digest of a password, may also be stored in the storage system 24.

Storage system 24 may alternatively be implemented using microprocessors and/or logic implemented on devices such as field programmable gate arrays (FPGAs) and complex programmable logic devices (CPLDs) that interface with non-volatile memory or a storage medium such as flash memory.

Storage medium 20 may comprise, for example, a 1.8″ hard disk drive, such as those manufactured by Toshiba or Hitachi. A 1.8″ hard disk drive is particularly suitable in this embodiment, as such a drive can be accommodated within the device 10 along with inline encryptor 22, storage system 24 and control system 30 (described below) within the standard dimensions of a 2.5″ hard disk drive.

The device 10 can be operated in two modes—an unauthenticated mode and an authenticated mode. The device initially operates in the unauthenticated mode after power on, until the user has been authenticated (by entering, when prompted, suitable authentication data such as a password or a username/password combination). Optionally, authentication may be required (or may additionally be required) by means of a smartcard or a biometric token (via the USB/parallel or serial interfaces of the computer) during this authentication stage for strong two or three factor authentication.

Once the user has been successfully authenticated, the device operates in authenticated mode until either power is removed or the device is instructed to terminate authenticated mode by the computer to which it is coupled.

In the unauthenticated mode, the storage system 24 is exposed on the interface 18 while in the authenticated state, the inline encryptor 22 is exposed on the interface 18.

The device 10 further includes a control system 30, which is the overall control system of the device 10. The control system 30 may contain additional non-volatile storage to hold encryption keys for encrypting data as it is transmitted to the storage medium 20 for storage in encrypted form. The bootable programs 26 can communicate with the control system 30 through interface 18, via a first bridge 32 implemented within storage system 24. The control system 30 controls the in-line encryptor 22 via a second bridge 34. Additionally, control system 30 may also configure and control the encryption algorithm of the in-line encryptor 22 or the mode of the encryption algorithm (for example, CBC and CFB modes). The second bridge 34 also provides a communication channel between an application running on the computer and the control system 30 in the authenticated state.

The specifications of the components of the device 10 are as follows:

| | |
|---|---|
| Storage Capacity & | 20/30 GB |
| Speed | 66/100 MB/s Ultra DMA Transfer |
| | Rate |
| Operating System | Operating system independent |
| | Tested with: Windows 98 (TM), |
| | Windows 2000 (TM), Windows XP |
| | (TM) and Linux (TM) |
| Interface & Mechanical | Standard 2.5″ HDD. Complies to |
| | SFF-8200, SFF-8201, SFF-8212 |
| | Size: 100(L) × 70(W) × 9.5(H) mm |
| Encryption Algorithm | 3DES (“Triple Data Encryption |
| | Standard”); key lengths from |
| | 40 to 192 bits |
| Authentication | Pre-boot authentication |
| Mechanisms | Password or USB cryptographic |
| | token |
| Certifications and | Designed to meet FIPS140-2 |
| Standards | Level 2 |
| | CE, FCC |

When the device 10 is in use, the bootable programs 26 can also access devices connected to the notebook computer 12. These devices include authentication devices or devices for inputting authentication data, including a keyboard, a smart card, a USB token 36 or a biometric device.

The operational flow of the device 10 is as follows:

(1) Upon powering on the notebook 12 and hence device 10, the control system 30 exposes one unit of the storage system 24 and hides the in-line encryptor 22.

(2) One of bootable programs 26 is loaded into the notebook computer 12, in the normal power-on process for the notebook computer 12. In this notebook hard disk embodiment, boot record 28 is loaded by the notebook computer 12, which loads this bootable program.

(3) This bootable program executes in notebook computer 12. It could execute to emulate a normal operating system booting process as a decoy, or it could authenticate the user to authorize him to access encrypted storage 20 via in-line encryptor 22. In the latter case, this bootable program authenticates the user by requesting that the user authenticate him-or herself using the relevant authentication device provided in or with the notebook computer 12. This could be implemented, for example, by:
(a) requesting that the user type in his or her password using a keyboard;
(b) requesting that the user type in his or her password and insert a smartcard or USB token; or
(c) requesting that the user present his biometric data, such as a fingerprint or iris scan.

(4) This bootable program communicates with the control system 30.

(5) If the user is authorized, the bootable program automatically reboots the notebook computer 12, while control system 30—by means of second bridge 34—configures and activates the in-line encryptor 22 and exposes its interface to interface 18.

(6) When the notebook computer 12 has rebooted (i.e. booted a second time), in-line encryptor 22 transparently encrypts all the data being stored to storage system 20 and decrypts all the data being read from storage system 20. From this point onwards, device 10 behaves like a normal storage drive onto which an operating system can be installed and used.

Thus, device 10 operates independently of the operating system installed on the storage medium it is protecting, and it can support multiple methods of authentication including password, smart card, USB token, etc. The device 10 can interface to an external authentication device, such as a smart card, USB token, etc., using existing interface(s) available on the host computer 12, and it can support one or more bootable programs 26 in addition to the storage medium 20 it is protecting.

As the device 10 is designed to a drop-in replacement for a notebook hard disk, it provides a convenient means for providing high data security in a notebook computer. This is particularly so when used with a USB security token 30 36.

The device 10 allows the encryption of every byte and every sector of data that is written into the hard disk 20. By encrypting every byte and sector, the device 10 is operating system independent, does not require any software drivers and thus users will not experience problems associated with software incompatibilities and patches. The device 10 encrypts all temporary files and areas that would normally be left vulnerable or “clear” by software file encryption products. Once a user is authenticated upon powering-on, encryption and decryption occurs transparently on-the-fly in the hardware without any degradation in notebook or disk performance. Users can use their notebooks normally, but with their data fully protected should their notebooks be stolen or lost.

According to this embodiment, the encrypted storage medium 20 is located within the casing 36 of device 10. However, in some applications it may be advantageous to locate the encrypted storage medium outside the casing. This would allow, for example, a user to use an existing storage medium as the encrypted storage medium by coupling to that existing storage medium a device that is comparable to device 10 but that omits storage medium 20.

Thus, a data protection device according to another embodiment of the present invention is shown generally at 40 in FIG. 4. As most of the features of the device 40 are identical with corresponding features of device 10 of FIG. 3, like reference numerals have been used to indicate like features.

Device 40 includes an interface 18, an in-line encryptor 22, a multiple storage system 24, bootable programs 26, boot record 28, control system 30, a first bridge 32 and a second bridge 34, all within a casing 36′. In addition, however, device 40 includes a further interface 42 (located where convenient, but in this embodiment at the opposite end of the casing casing 36′ from interface 18) for coupling the device 40 to an existing storage medium (not shown). When connected to that existing storage medium, the combination of device 40 and existing storage medium function and are operated in the same manner as device 10.

Device 40 can thus be used as an add-on module and connected, for example, between the ATA/SATA connector of the computer and an existing, off-the shelf ATA/SATA hard disk drive. Such an embodiment could be advantageous in the case of desktop computers and servers.

Modifications within the scope of the invention may be readily effected by those skilled in the art. For example, an alternative embodiment can comprise a portable USB/IEE1394 protected data storage device comparable to either device 10 or device 40. It is to be understood, therefore, that this invention is not limited to the particular embodiments described by way of example hereinabove.

In the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A device for protecting data, comprising:
an interface for connection to a computing device;
a data storage;
an encryptor located in-line between said interface and said data storage;
a control system; and
a memory;
wherein said memory includes program data executable on said computing device to perform user authentication, said control system is configured to initially expose said memory to said interface to facilitate user authentication and to expose said encryptor to said interface only upon successful user authentication, and said encryptor is operable to encrypt on the fly data received from said interface and to forward said data once encrypted to said data storage and to decrypt on the fly data received from said data storage and to forward said data once decrypted to said interface.

2. A device as claimed in claim 1, wherein said control system is configured to reboot said computing device after successful user authentication and before exposing said encryptor to said interface.

3. A device as claimed in claim 1, wherein said memory comprises a portion of a memory storage system provided with one or more bootable programs.

4. A device for protecting data, comprising:
a first interface for connection to a computing device;
a second interface for connection to a data storage;
an encryptor located in-line between said first interface and said second interface;
a control system; and
a memory;
wherein said memory includes program data executable on said computing device to perform user authentication, said control system is configured to initially expose said memory to said interface to facilitate user authentication and to expose said encryptor to said interface only upon successful user authentication, and said encryptor is operable to encrypt on the fly data received from said first interface and to forward said data once encrypted to said second interface and to decrypt on the fly data received from said second interface and to forward said data once decrypted to said first interface.

5. A device as claimed in claim 4, wherein said control system is configured to reboot said computing device after successful user authentication and before exposing said encryptor to said interface.

6. A method of protecting data, comprising:
locating an encryptor in-line between a data storage and an interface to a computing device;
exposing a memory to said interface to facilitate user authentication;
exposing said encryptor to said interface only upon successful user authentication;
encrypting on the fly data received from said first interface and forwarding said data once encrypted to said second interface; and
decrypting on the fly data received from said second interface and forwarding said data once decrypted to said first interface.
